(19) United States
(12) Patent Application Publication
(10) Pub. No.: US 2007/0236927 A1
(43) Pub. Date: Oct. 11, 2007

(54) Plaine light source apparatus

(75) Inventor: Ming-Dah Liu, Hsinchu (TW)

Correspondence Address: BACON & THOMAS, PLLC, 625 SLATERS LANE, FOURTH FLOOR, ALEXANDRIA, VA, 22314, US

(73) Assignee: Coretronic Corporation, Hsinchu (TW)

(21) Appl. No.: 11/656,411

(22) Filed: Jan. 23, 2007

(30) Foreign Application Priority Data
Apr. 6, 2006 (TW) 095112287

(51) Int. Cl. F21S 19/00

(52) U.S. Cl. 362/228

(57) ABSTRACT

A plane light source apparatus mainly comprises at least one illumination element and a light guiding module. The light guiding module comprises a light guiding bar and a light guiding plate, in which the light guiding element is used for generating light beams. The light guiding bar includes at least one surface used for disposing the illumination element and a reflection surface used for receiving the light beams emitted from the illumination elements. The light guiding plate has a plurality of end surfaces, one of end surfaces is connected to the light guiding bar. A gap is used for guiding the line light source to be incident into an area of the light guiding plate far away from the light guiding bar and exists between the light guiding bar and the light guiding plate. Whereby, the whole uniformity of the backlight module is elevated.

### BACKGROUND OF THE INVENTION

1. Field of the Invention

The present invention relates to a plane light source apparatus, and more particularly to a plane light source apparatus applied in a backlight module.

2. Description of Related Art

It is necessary for a general liquid crystal display or a liquid crystal television to provide a light source through a backlight module. The light source is generated by reducing a several cold cathode tubes to a point light source (e.g. light emitting diode) for attaining to the thinning of a system. Please refer to FIG. 1. A conventional plane light source apparatus 10 mainly comprises a light emitting diode (LED) 11 and a light guiding plate 12, in which a point light source generated from the LED 11 is incident into a side end surface 121 of the light guiding plate 12 and then incident into the bottom surface 122 of the light guiding plate 12. Diffusion points disposed on the bottom 122 of the light guiding plate 12 is utilized to destroy the total reflection phenomena to enable light beams to be guided toward a front surface of the light guiding plate 12 to generate a plane light source, and optical elements (not shown in the figure) disposed on the light guiding plate 12 is utilized to guide the light source toward a LCD panel (not shown in the figure).

Nevertheless, light beams incident into the light guiding plate 12 are concentrated close to an area adjacent to the LED 11 such that the entire uniformity of the backlight module 10 is bad. Therefore, how to allow the light beams to be uniformly incident into the light guiding plate 12 and control the light beams to be incident into the distribution areas of the light guiding plate 12 so as to increase the entire uniformity of the backlight module 10 is the topic of the present invention.

### SUMMARY OF THE INVENTION

One object of the present invention is to provide a plane light source apparatus, guiding light beams to be incident into an area of a light guiding plate far away from a light guiding bar by disposing a gap between the light guiding bar and light guiding plate in a light guiding module so as to increase the entire uniformity of a backlight module.

Another object of the present invention is to provide a plane light source apparatus, only a single mold and one injection are needed on the manufacturing to allow a light guiding bar and a light guiding plate to be manufactured at the same time by partly connecting the light guiding bar to the light guiding plate so as to simplify the manufacturing procedures.

Still another object of the present invention is to provide a plane light source apparatus, allowing effective illumination light beams incident into a light guiding plate to be increased by dispositions of diffusion points on a left end surface of a light guiding bar and a wedge-shaped structure of the light guiding bar.

Still another object of the present invention is to provide a plane light source apparatus, adjusting light energy input to a light guiding plate to effectively control distribution areas of the light guiding plate to which light beams are incident into the light guiding plate by changing disposition density of diffusion points on a reflection surface of a light guiding bar.

For attaining to the objects mentioned above, a plane light source apparatus according to the present invention comprises at least one illumination element and a light guiding module, the light module comprises a light guiding bar and a light guiding plate. The illumination element is used for generating light beams, and the light guiding bar has at least one surface used for disposing the illumination element and a reflection surface used for receiving the light beams emitted from the illumination element. The light guiding plate has a plurality end surfaces, one of the end surfaces is connected to the light guiding bar. A gap exists between the light guiding bar and the light guiding plate and is used for guiding a line light source to incident into an area of the light guiding plate far away from the light guiding bar to increase the entire uniformity of a backlight module and increase the effective illumination light beams incident into the light guiding plate through the diffusion points disposed on the reflection surface of the light guiding bar.

### BRIEF DESCRIPTION OF THE DRAWINGS

The present invention can be more fully understood by reference to the following description and accompanying drawings, in which:

FIG. 1 is a schematic view of an optical path of a conventional plane light source apparatus;

FIG. 2 is a schematic view of an optical path of a plane light source apparatus according to the present invention;

FIG. 3 is a schematic view of an optical path of a plane light source apparatus according to the present invention;

FIG. 4 is a schematic view of a plane light source apparatus of another preferred embodiment according to the present invention; and

FIGS. 5 to 8 are schematic views of other applicative forms of plane light source apparatus according to the present invention.

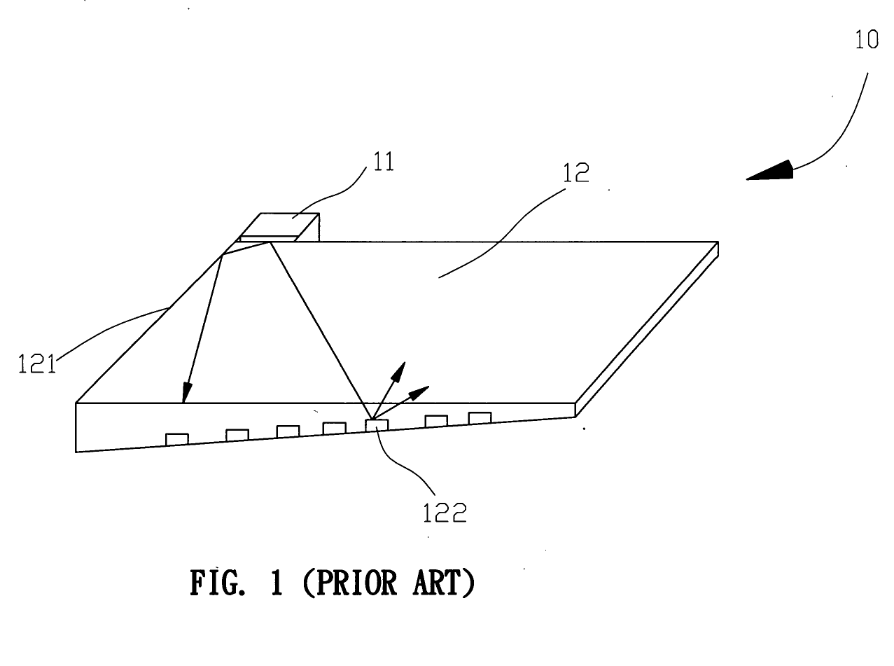

### DETAILED DESCRIPTION OF THE PREFERRED EMBODIMENTS

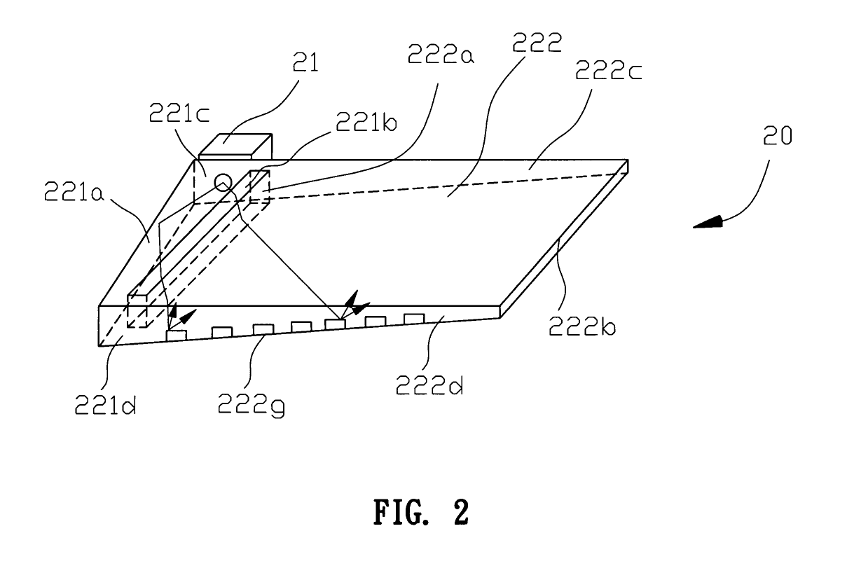

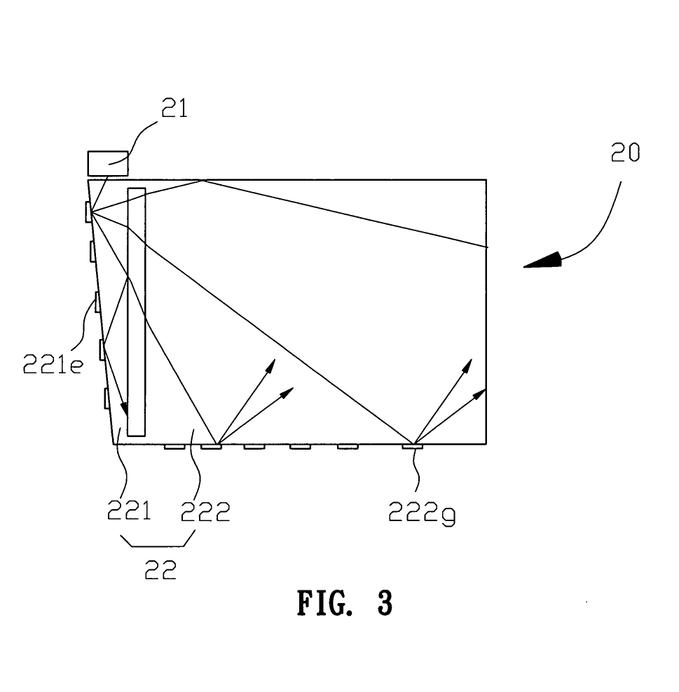

Please refer to FIGS. 2 and 3. A plane light source apparatus 20 comprises an illumination element 21 and a light guiding module 22, in which the light guiding module 22 comprises a light guiding bar 221 and a light guiding plate 222. The illumination element 21 is a white LED used for generating a white point light source or generating a white or other color point light source by mixing red, green and blue LEDs. Besides, the LED can be constituted by a single chip or a plurality of chips. The illumination principle here mainly is to utilize the LED chips to be matched up with fluorescent powder first, excite them, and then mix them to generate with light beams. The light guiding bar 221 of the light guiding module 22 has a reflection surface 221a and a light outputting surface 221b, and a top end surface 221 and a bottom end surface 221d connected with the reflection surface 221a and the light outputting surface 221b. Furthermore, diffusion points 221c are disposed on the reflection surface 221a and a wedge shape is formed by gradually thinning the light guiding bar 221 in a direction from the top end surface 221c toward the bottom end surface 221d. Moreover, the reflection surface 221a and the light outputting surface 221 are disposed surface to surface, the illumination element 21 is disposed outside the top end surface 221c and the material of the light guiding bar 22 is a transparent material. The light guiding plate 222 has a left end surface 222a, a right end surface 222b and a top end surface 222c and a bottom side surface 222d formed surface to surface and perpendicular to the left end surface 222a or the right end surface 222b; the whole thickness of the wedge-shaped light guiding plate 222 is gradually thinned in a direction from the left end surface 221a toward the right end surface 222b and a plurality of diffusion points 222g are disposed on the lower end surface 222f furthermore, the top end surface 221c and the bottom end surface 221d of the light guiding bar 221 are respectively connected with the top end surface 222c and the bottom 222d of the light guiding plate 222 and a gap, which is a groove or a through hole, is formed between the right end surface 221b of the light guiding bar 221 and the left end surface 222a of the light guiding plate 222.

The illumination element 21 of the plane light source apparatus 20 according to the present invention is a LED. A point light source emitted from the illumination 21 is first partly incident into the light guiding module 22 and transmitted into the reflection surface 221a of the light guiding bar 221 via the top end surface 221c of the light guiding bar 221 in the light guiding module 22. Light beams of the point light source can be diffused and uniformed to convert to a line light source through the diffusion points 221e disposed on the reflection surface 221a of the light guiding bar 221, and the full reflection is destroyed by means of the wedge shape structure thinned from the top end surface 221c toward the bottom end surface 221d to allow the light beams of the line light source converted at the reflection surface 221a to be transmitted to the light outputting surface 221b and be then incident into the left end surface 222a of the light guiding plate 222 via an air interface of the gap. Next, the light beams of the line light source is incident into the lower end surface 222f of the light guiding plate 222, caused to diffuse and uniform through the diffusion points 222g disposed on the lower end surface 222f of the light guiding plate 222 and finally output via the upper end surface 222c of the light guiding plate 222 to generate a surface light source to be used as a light source of a liquid crystal panel (not shown in the figure).

The air interface existing in the gap disposed between the light guiding bar 221 and the light guiding plate 222 of the light guiding module 222 according to the present invention is used for guiding the light beams to be incident into an area of the light guiding plate 222 far away from the light guiding bar 212 so as to elevate the entire uniformity of the backlight module. Moreover, the light outputting surface 221b of the light guiding bar 221 and the left end surface 222a of the light guiding plate 222 are respectively connected with the top end surface 222c and the bottom end surface 222d of the adjacent light guiding plate 222 to allow the light guiding bar 221 and the light guiding plate 222 to be manufactured simultaneously only by means of a single mold and once injection on the manufacturing so as to simplify the manufacturing processes. Besides, the line light source converted through the light guiding bar 221 can also be allowed to generate light beams with uniform energy by changing the disposition density of the diffusion points 221e on the reflection surface 221a of the light guiding bar 221 according to the present invention so as to adjust the light energy input to the light guiding plate 222 and properly effectively control the distribution areas of the light guiding plate 222 to which the light beams is incident.

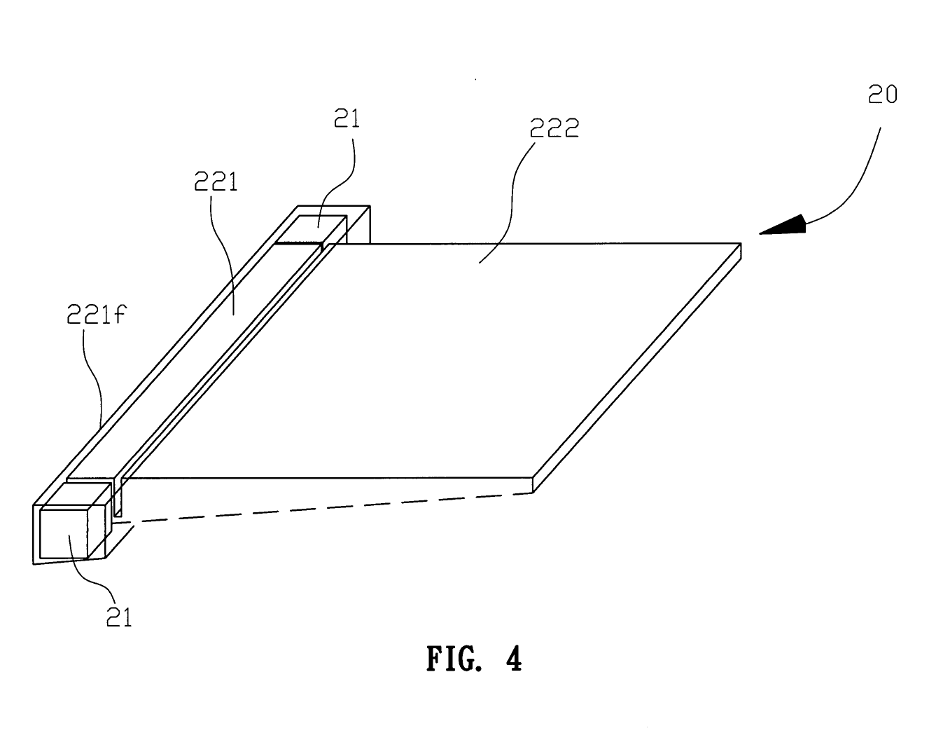

Next, please refer to FIG. 4. The difference between a second preferred embodiment of the present invention and the first embodiment is in that the illumination elements 21 are respectively disposed outside the top end surface 221c and the bottom end surface 221d of the light guiding bar 221 in the light guiding module 22, the light guiding bar is formed to be a plate with a same thickness from the top end surface 221c to the bottom end surface 221d. A gap is formed by connecting a lower end surface 228 of the light guiding bar 221 to a lower end surface 246 of the light guiding plate 222 and a plurality of reflection sheets 221f are covered on the surroundings of the upper end surface 221g of the light guiding bar 221 and the gap so as to increase the effective illumination light beams incident into the light guiding plate 222.

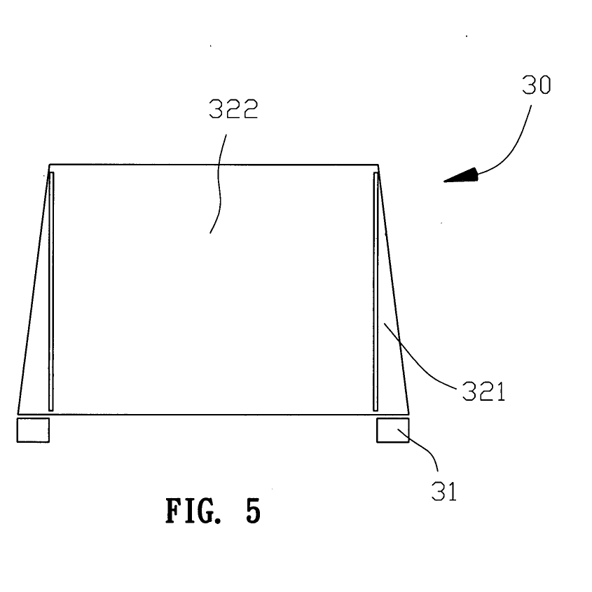

Please refer to FIG. 5. A plane light source apparatus 30 according to the present invention comprises two light guiding bars 321 and a light guiding plate 322. The wedge-shaped light guiding bars are respectively disposed at a left end side 322a and a right end side 322b of the light guiding plate 322 and two illumination elements 31 are respectively disposed at bottom end surfaces 321b of the light guiding bars 321 in a light guiding module 32. Besides, a gap is formed between each light guiding bar 321 and the light guiding plate 322.

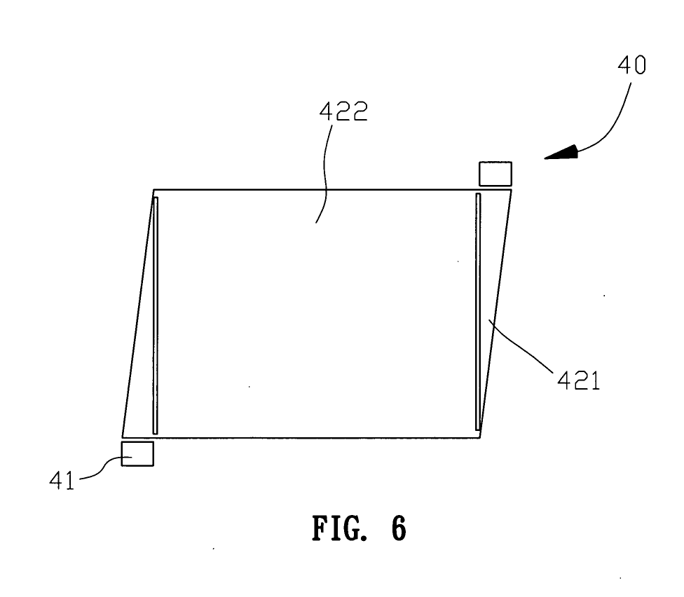

Please refer to FIG. 6. Two illumination element 41 are disposed at diagonal ends of a light guiding plate 442 in a plane light source apparatus 40 according to the present invention and two wedge-shaped light guiding bar 441 are respectively disposed at the a left end surface 442a and a right end surface 442b of the light guiding plate 442. Besides, a gap is formed between each light guiding bar 441 and the light guiding plate 442.

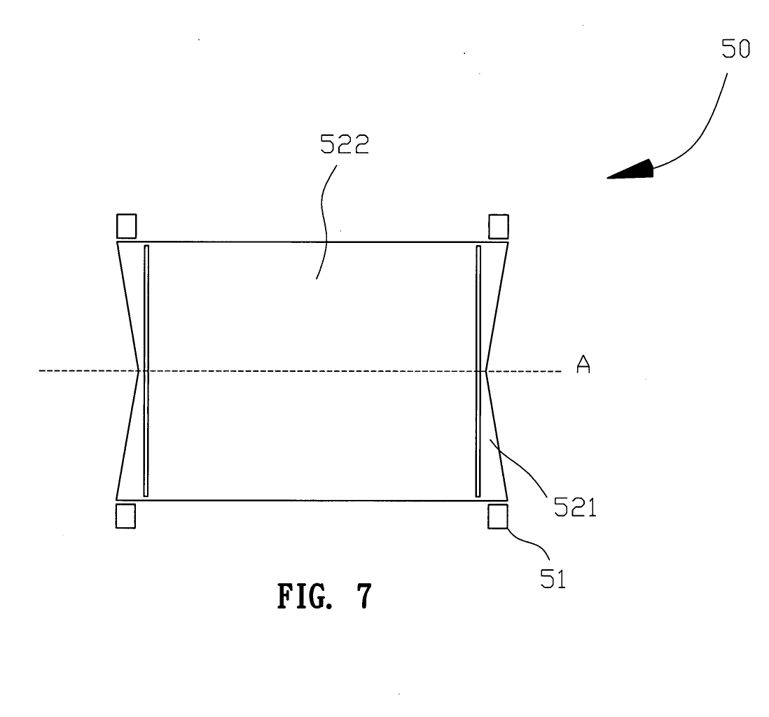

Please refer to FIG. 7. A plurality of illumination elements 51 is respectively disposed at a top end surface and a bottom end surface of a light guiding bar 521 of a plane light source apparatus 50 according to the present invention. Each light guiding bar 521 is formed to be a wedge shape gradually thinned in a direction from the top end surface or the bottom surface of the light guiding bar 521 toward a central line A of a light guiding plate 522.

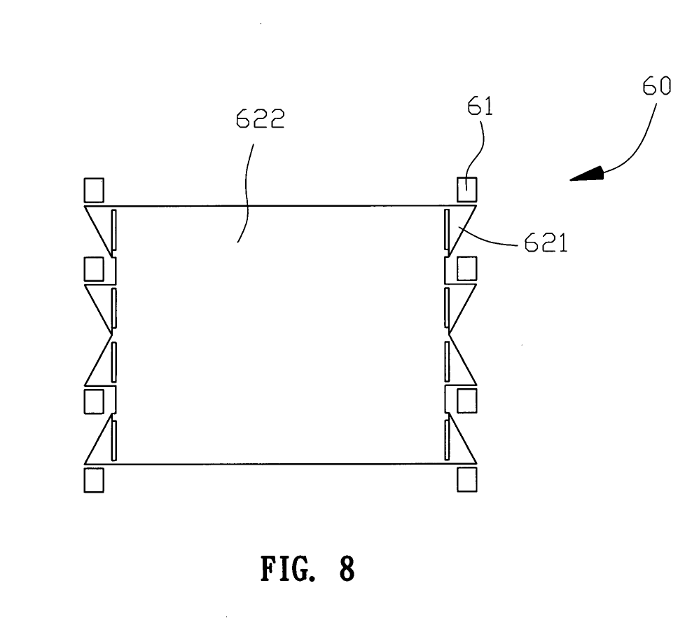

Please refer to FIG. 8. A plurality of wedge-shaped light guiding bars 621 is respectively disposed at a left end surface 622a and a right end surface 622b of a light guiding plate 622 in a plane light source apparatus 60 according to the present invention. A gap is formed between each light guiding bar 621 and the light guiding plate 622. A plurality of illumination elements 61 is respectively disposed at a top end surface 623, bottom end surface 624 and two flank sides of the light guiding plate 622, and an illumination element is disposed between each two adjacent wedge-shaped light guiding bar 621. The illumination elements 61 and the wedge-shaped bars 621 are used for allowing the illumination light beams incident into the light guiding plate 622 to be increased so as to elevate the brightness of the light beams incident into light guiding plate 622. Besides, the illumination element of the present invention can be not only a LED but also a light bulb, nano-lamp or OLED; these all can attain to the same effect.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A plane light source apparatus, comprising:
at least one illumination element, used for generating light beams; and
a light guiding module, comprising a light guiding bar and a light guiding plate, said light guiding bar having at least one surface used for disposing said illumination elements and a reflection surface used for receiving said light beams emitted from said illumination elements, said light guiding plate having a plurality of end surfaces, one of said end surfaces being connected to said light guiding bar, and a gap existing between said light guiding bar and said light guiding plate.

2. The plane light source apparatus according to claim 1, wherein said illumination is a LED.

3. The plane light source apparatus according to claim 1, wherein said illumination element is a light bulb.

4. The plane light source apparatus according to claim 1, wherein said illumination element is a nano-lamp.

5. The plane light source apparatus according to claim 1, wherein said illumination element is an OLED.

6. The plane light source apparatus according to claim 1, wherein said light guiding bar is a transparent material.

7. The plane light source apparatus according to claim 1, wherein a plurality of diffusion points is disposed on a reflection surface of said light guiding bar.

8. The plane light source apparatus according to claim 7, wherein the disposition density of said diffusion points is changeable.

9. The plane light source apparatus according to claim 1, wherein the said light guiding bar and said gap are surrounded by a plurality of reflection sheets.

10. The plane light source apparatus according to claim 1, wherein said light guiding bar is plate-typed.

11. The plane light source apparatus according to claim 1, wherein said light guiding bar is wedge-typed.

12. The plane light source apparatus according to claim 1, wherein said gap is a groove.

13. The plane light source apparatus according to claim 1, wherein said gap is a through hole.

14. The plane light source apparatus according to claim 1, wherein said gap is an air interface.
